(19) United States
(12) Patent Application Publication
(10) Pub. No.: US 2006/0054142 A1
(43) Pub. Date: Mar. 16, 2006

(54) Engine intake hydrocarbon trap system

(76) Inventors: David H. Burke, Victor, NY (US); Kenneth W. Turner, Mendon, NY (US); Stephen T. Mahan, Milford, MI (US)

Correspondence Address: Jimmy L. Funke, Esq.;Delphi Technologies, Inc., Mail Code 480410202, P.O. Box 5052, Troy, MI, 48007, US

(21) Appl. No.: 10/941,737

(22) Filed: Sep. 15, 2004

(51) Int. Cl. F02M 33/04

(52) U.S. Cl. 123/518

(57) ABSTRACT

An air intake hydrocarbon vapor trap system for an internal combustion engine comprising a hydrocarbon-adsorptive medium, such as activated carbon, disposed in a gravitationally low point in the intake air flow passageway between the entrance to the system and the engine. The intake duct itself is configured to provide the low region for disposition of the medium. The medium is thereby fully exposed to the flow of gases through the duct and is not confined to a separate walled pit as in the prior art. The medium, for example, activated carbon, may be provided in any of several forms, such as in a pelletized bed, a rigid formed structure, or as a “sheet” or “paper.” Preferably, the medium is disposed in the engine compartment to optimally transfer heat away from it during engine shut-down.

### TECHNICAL FIELD

The present invention relates to internal combustion engines; more particularly, to devices for preventing escape of hydrocarbon vapors from internal combustion engines; and most particularly, to a hydrocarbon vapor trap disposed in the air intake portions of such an engine for adsorbing vapors when the engine is shut down.

### BACKGROUND OF THE INVENTION

Gasoline-fueled motor vehicles have numerous sites from which gasoline hydrocarbons (HC) can evaporate into the atmosphere. Atmospheric HC is a major contributor to smog formation; thus, there is great interest in providing means for reducing or preventing inadvertent escape of HC vapors from vehicles and their internal combustion engines.

The control of HC vapors escaping into the atmosphere is also the subject of substantial state and federal regulations. For example, The California Air Resources Board (CARB) has adopted stringent vapor emissions regulations, known generally as Low Emission Vehicle II (LEV II) and Partial Zero Emission Vehicle (PZEV). LEV II regulations, running from 2004 through 2010, represent continuing progress in emission reductions. As the state's passenger vehicle fleet continues to grow and more sport utility vehicles and pickup trucks are used as passenger cars rather than work vehicles, the new, more stringent LEV II standards are necessary for California to meet federally-mandated clean air goals outlined in the 1994 State Implementation Plan (SIP).

Vapor traps are well known. For example, present-day vehicles are commonly equipped with an adsorptive canister system for preventing the escape of hydrocarbon vapors displaced from a vehicle's fuel tank during refueling of the vehicle.

Fuel vapors can also escape from an engine via the air intake system after the engine is shut down. Residual fuel in the air intake manifold, whether from fuel injection or carburetion, or from ventilation of the crankcase, is readily vaporized by residual engine heat and can migrate out of the engine through the air intake opening.

Various approaches are known in the art for preventing such migration. For one example, the throttle valve may be closed, thus trapping vapors within the manifold. A disadvantage of this approach is that it requires an electronic throttle control, which may also eliminate a “limp home” mode of engine operation if there is a problem with the electronics. For another example, carbon grids may be added between the air cleaner and the throttle plate. A disadvantage of this approach is that the carbon grids obscure a significant portion of the cross-sectional area of the air flow path service to reduce engine power and, if not closely-spaced, can be relatively inefficient.

Yet another approach is disclosed by U.S. Pat. No. 6,505,610 ('610), the relevant disclosure of which is incorporated herein by reference, comprising an engine intake system through which ambient air enters a combustion engine to be combusted with hydrocarbon fuel in combustion chamber space of the engine for running the engine. A walled main intake passageway has an upstream end communicated to ambient atmosphere and a downstream end communicated to the engine combustion chamber space. An imperforate walled pit encloses an interior space disposed at an elevation vertically below an imperforate wall of the main intake passageway and includes an imperforate wall separating the pit interior space from the main passageway. The pit has a first entrance communicating the interior space to ambient atmosphere and a second entrance communicating the interior space to the main intake passageway through the imperforate wall of the main passageway for enabling gaseous hydrocarbon that is heavier than air to fall into the interior space upon encountering the second entrance of the pit when migrating upstream within the main intake passageway toward the second entrance of the pit from the downstream end of the main passageway. A medium disposed within the interior space collects gaseous hydrocarbon that has fallen through the entrance opening into the pit. The air flow is reversed when the engine is restarted, and the collected hydrocarbon is stripped from the medium and returned to the main passageway to be conveyed to the combustion space.

A significant drawback of the disclosed hydrocarbon trap is the bulk and added cost of providing a walled pit separate from and below the main air passageway. It is well known in the automotive arts that underhood space is very limited and is not readily available for an additional walled pit. In addition, not all vapors will fall into the pit; some may pass by the entrance and thereby be lost to the atmosphere.

What is needed in the art is a hydrocarbon trap for an engine air intake system which does not significantly impede the flow of air; which does not consume significant additional underhood space; which does not require a separate walled pit; and which is exposed to all the air flowing through the system to optimize adsorption and subsequent desorption of hydrocarbons.

It is a principal object of the present invention to minimize the escape of hydrocarbon vapors from an engine air intake system after the engine is turned off.

### SUMMARY OF THE INVENTION

Briefly described, an air intake hydrocarbon vapor trap in accordance with the invention comprises a hydrocarbon-adsorptive medium, such as activated carbon, disposed in a gravitationally low point in the intake air flow path between the entrance to the system and the intake manifold. Preferably, the intake duct itself is configured to accentuate a low region for disposition of the medium. The medium is fully exposed to the flow of gases through the duct and is not confined to a separate walled pit as in the prior art. The medium, as activated carbon, may be provided in any of several forms, such as in a pelletized bed, a rigid formed structure, or as a “sheet” or “paper.”

Hydrocarbon adsorption by the activated carbon medium is inversely proportional to the temperature at the adsorption site. That is, lowering the temperature at the adsorption site has the effect of increasing adsorption. In a preferred embodiment in accordance with the invention, The intake duct supporting the medium is located so as to conduct the heat of combustion contained in the intake duct away from the medium to lower the temperature of the medium thereby optimizing hydrocarbon adsorption.

### BRIEF DESCRIPTION OF THE DRAWINGS

The present invention will now be described, by way of example, with reference to the accompanying drawings, in which:

FIG. 1 is a prior art hydrocarbon vapor trap substantially as disclosed in the '610 incorporated reference;

FIG. 2 is a schematic view of a hydrocarbon vapor trap and associated internal combustion engine, in accordance with the invention;

FIG. 3 is a longitudinal cross-sectional view of a first embodiment of the trap shown in FIG. 2;

FIG. 4 is a longitudinal cross-sectional view of a second embodiment;

FIG. 5 is a longitudinal cross-sectional view of a third embodiment;

FIG. 6 is a transverse cross-sectional view, taken along line A-A in FIG. 4, showing a first adsorptive medium configuration;

FIG. 7 is a transverse cross-sectional view, taken along line A-A in FIG. 4, showing a second adsorptive medium configuration;

FIG. 8 is a transverse cross-sectional view, taken along line A-A in FIG. 4, showing a third adsorptive medium configuration;

FIG. 9 is the view shown in FIG. 8 with finned heat sink projections added.

### DESCRIPTION OF THE PREFERRED EMBODIMENTS

The advantages conferred by the present invention may be better appreciated by first considering a prior art hydrocarbon trap system for an engine air intake, substantially as disclosed in U.S. Pat. No. 6,505,610.

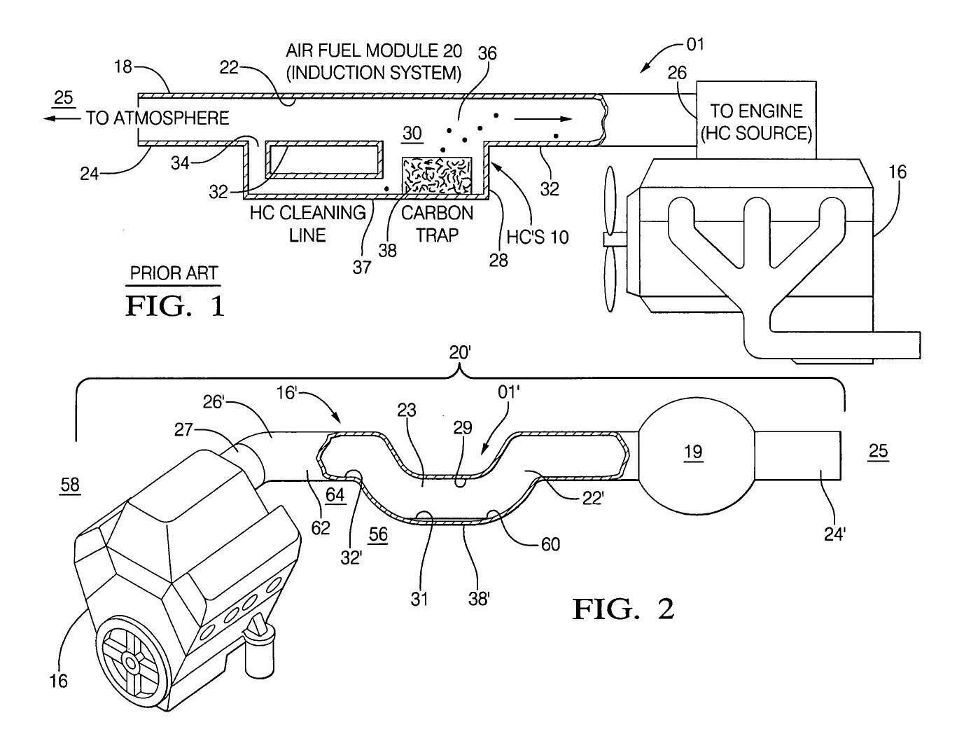

Referring to FIG. 1, in a prior art hydrocarbon trap system 01, an internal combustion engine 16 comprises an intake system 18 through which ambient air enters the engine for combustion with hydrocarbon fuel for running the engine. The fuel may be introduced by a fuel injection system that together with the intake system may be embodied as air-fuel module 20. When engine 16 is naturally aspirated, the module acts as an induction system wherein engine vacuum inducts air and fuel into the individual engine cylinders.

Module 20 comprises a walled main intake passageway 22 that has an upstream end 24 communicated to ambient atmosphere 25 and a downstream end 26 communicated to the engine combustion chamber space, typically through intake valves (not shown) that operate in suitably timed relation to engine operation. An imperforate walled pit 28, that may be integrally formed with module 20, encloses an interior space 30 disposed at an elevation vertically below an imperforate bottom wall 32 of main passageway 22. Pit 28 has a first entrance 34 communicating interior space 30 to ambient atmosphere 25 and a second entrance 36 communicating interior space 30 to main intake passageway 22 through imperforate wall 32.

Entrance 34 comprises a separate hydrocarbon cleaning line, or conduit, 37 that runs from wall 32 to the bottom wall of pit 28. Conduit 37 is separate from walled main intake passageway 22 and runs parallel to passageway 22. A suitable medium 38 for collecting hydrocarbon is disposed within interior space 30. An example of a suitable medium is activated carbon.

When engine 16 is running, atmospheric air is drawn through passageway 22 and into engine 16 wherein it forms, with injected fuel, a combustible mixture that is ignited to power the engine. The parallel path through line 37 and pit 28 imposes no significant restriction to the intake airflow.

When engine 16 stops running, certain hydrocarbons may be present in passageway 22 proximate engine 16, and they may tend to migrate upstream through passageway 22 along wall 32 toward upstream end 24. Upon encountering entrance 36, however heavier-than-air hydrocarbons 10 will fall through into interior space 30. When they come in contact with medium 38, the molecules will be adsorbed by the medium. In this way, those molecules are collected and prevented from escaping to atmosphere, thereby preventing their emission to the environment.

When engine 16 is again run, a small amount of intake air may pass through cleaning line 37 to purge molecules from medium 38. As air passes across the medium, collected hydrocarbon molecules entrain with the air, and the mixture exits pit 28 through entrance 36 to re-enter the intake airflow through main passageway 22 and pass into engine 16.

As noted above, a problem with the prior art apparatus is its bulk and the fact that not all the air and hydrocarbon migrating upstream after engine shutdown is shunted past the adsorption medium, the medium being confined to a separate chamber in pit 28. The prior art apparatus, therefore, is believed to be relatively inefficient. While performing the same function as the prior art apparatus in much the same way, the present invention overcomes these two disadvantages (bulk and inefficiency).

Referring to FIG. 2, in an improved hydrocarbon trap system 01′ in accordance with the invention, an internal combustion engine 16 comprises an intake system 18′ through which ambient air enters the engine for combustion with hydrocarbon fuel for running the engine, preferably including air cleaner 19. The fuel may be introduced by a fuel injection system that together with the intake system may be embodied as air-fuel module 20′. When engine 16 is naturally aspirated, the module acts as an induction system wherein engine vacuum inducts air and fuel into the individual engine cylinders.

Module 20′ comprises a walled main intake passageway 22′ that has an upstream end 24′ communicated to ambient atmosphere 25 and a downstream end 26′ communicated to the engine combustion chamber space, typically through a throttle valve 27 and intake valves (not shown) that operate in suitably timed relation to engine operation in known fashion.

Main intake passageway 22′ includes, as an integrated part to form a continuous passageway, passageway portion 23. That is, passageway portion 23 runs in series with main intake passageway 22′ and is not running as a separate line parallel to main intake passageway 22′ as in the case of main intake passageway 22 to conduit 37 shown in prior art trap system 01 (FIG. 1).

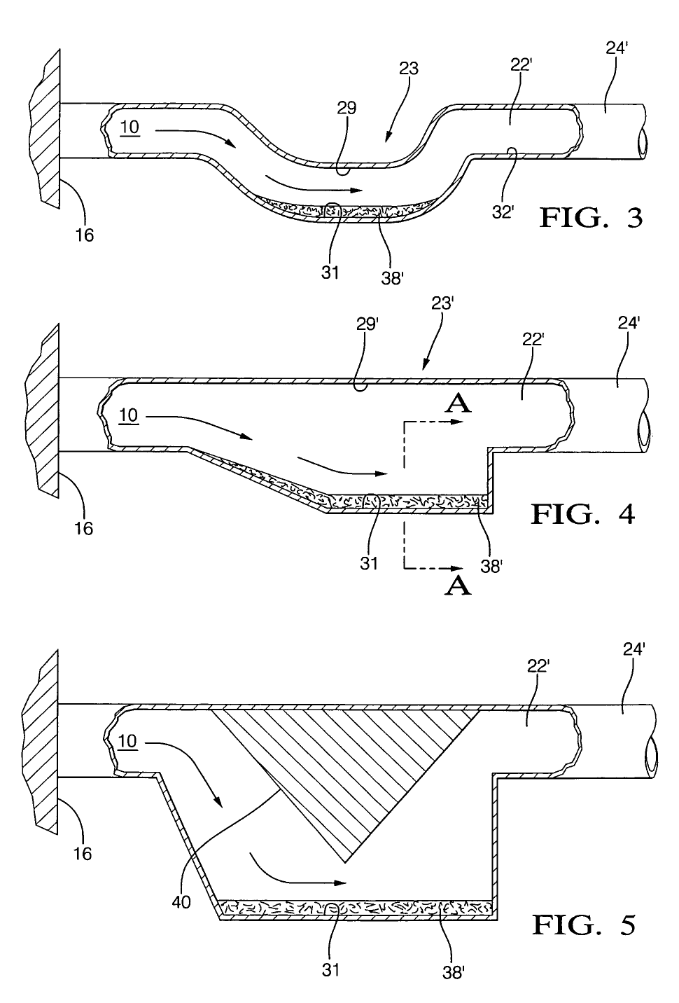

Main intake passageway 22′ is preferably configured such that a bottom wall 31 of passageway portion 23 preferably is disposed at an elevation vertically below bottom wall 32′ of main intake passageway 22′, as shown in detail in FIG. 3. Preferably, bottom wall 31 is the lowest point within portion 23 and main intake passageway 22′. Preferably, upper wall 29 of portion 23 is disposed at an elevation vertically below bottom wall 32′ of main intake passageway 22′.

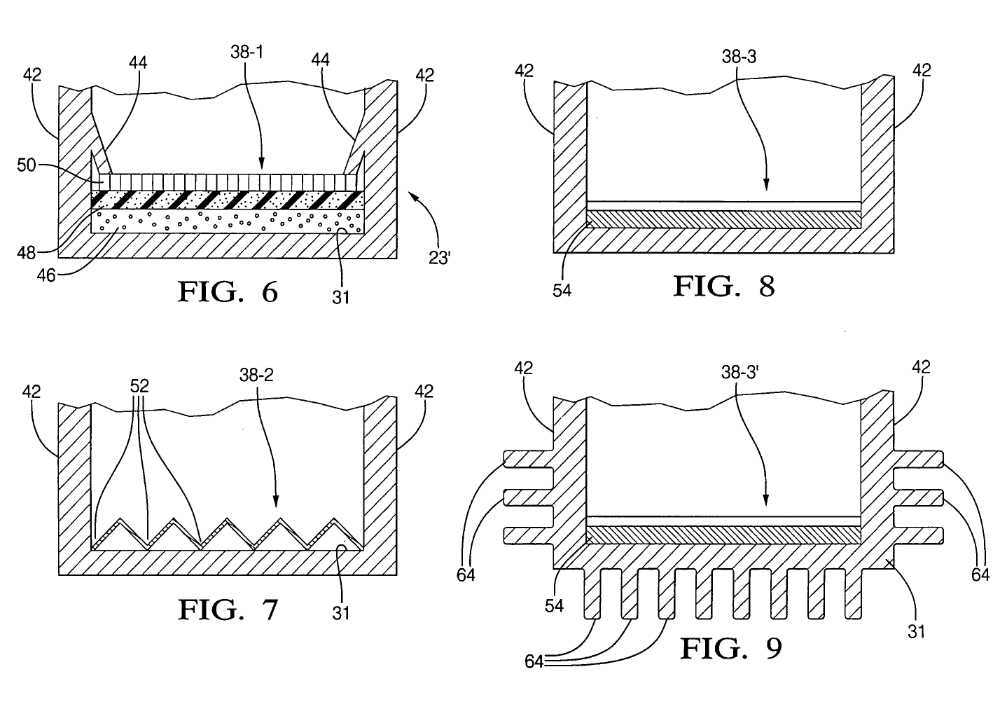

A suitable medium 38′ for collecting hydrocarbon is disposed within portion 23, for example, along the bottom wall 31 thereof. An example of a suitable medium is activated carbon, as may be formed into any of various shapes, some exemplary forms of which are shown in FIGS. 6 through 8, as discussed hereinbelow.

When engine 16 is running, atmospheric air is drawn through main intake passageway 22′ and into engine 16 wherein it forms, with injected fuel, a combustible mixture that is ignited to power the engine. The path through portion 23 and past medium 38′ imposes no significant restriction to the intake airflow.

When engine 16 stops running, certain hydrocarbons may be present in main intake passageway 22′ proximate engine 16, and they may tend to migrate upstream through passageway 22′ along bottom wall 32′ toward upstream end 24′. Upon encountering portion 23, however heavier-than-air hydrocarbons will fall to the lowest portions of main intake passageway 22′ in portion 23. When the hydrocarbon molecules come into contact with medium 38′, the molecules are adsorbed by medium 38′. In this way, those molecules are collected and prevented from escaping to atmosphere, thereby preventing their emission to the environment.

When engine 16 is again run, intake air passes through portion 23 and thereby purges the HC molecules from medium 38′ which re-enter the intake airflow through main intake passageway 22′ and pass into engine 16.

Referring to FIG. 3, upstream flow of HC vapors 10 from engine 16 is directed downwards into portion 23 by the gravitational relationship of portion 23 to main intake passageway 22′. This flow direction urges the HC vapors toward medium 38′ which is distributed along a region of bottom wall 31. In contrast to prior art embodiment 01, the entire flow of air and HC vapors in passageway 22′ is made available to the medium. Preferably the cross-sectional area of portion 23 is sized to accommodate the thickness of medium 38′ such that portion 23 presents no significant restriction to the flow of air to the engine during operation thereof.

Referring to FIG. 4, the upper wall 29′ of portion 23′ is continuous with the upper wall of main intake passageway 22′; this configuration provides a straighter path for intake air while also providing a low region for accumulation of HC vapors but at a cost of less direction for the vapors when the engine is off. This configuration is applicable to an engine requiring lesser improvement in evaporative emissions.

Referring to FIG. 5, portion 23″ is similar to portion 23′ but includes a spoiler 40 extending downwards from the upper wall of passageway 22′, providing strong direction to vapors migrating along passageway 22′ from engine 16.

In any of portions 23,23′,23″, medium 38′ may extend along bottom wall 31, both laterally and longitudinally, as shown in FIGS. 3 and 4, including along the inclined entrance to the portion, to present a relatively large surface area for vapor adsorption.

Referring to FIG. 6, a first embodiment 38-1 of medium 38′ is disposed in portion 23′ on bottom wall 31 and between sidewalls 42 thereof and is retained in place by, for example, tabs 44 extending from sidewalls 42. Medium 38-1 comprises a layer of granulated or pelletized carbon 46 overlain by a sheet 48 of open cell foam and a rigid grid element 50. These forms of activated carbon have the advantages of being readily available and inexpensive.

Referring to FIG. 7, a rigid carbon form 38-2 comprises a surface pattern of longitudinal grooves 52 to increase surface area. The surface topography may include any shapes to increase surface area, or may be flat to minimize flow restriction. Methods for making rigid carbon forms are well known in the art.

Referring to FIG. 8, a carbon “sheet” or “paper” 54 comprising carbon form 38-3 is disposed along bottom wall 31 and may also be extended along walls 42 as desired. An exemplary material is an Activated Carbon Sheet, Stock Number ACS-135/270, available from MeadWestvaco Corporation, Stamford, Conn., USA. Sheet 54 may be retained in portion 23′ as by tabs 44 (FIG. 6), by adhesives, or by any other convenient means of attachment.

The medium configurations 38-1,38-2,38-3 are shown for simplicity in respect to embodiment 23′ shown in FIG. 4 but of course these medium configurations are equally applicable to all configurations of trap portions 23, 23′, 23″.

Referring again to FIG. 2, preferably passageway 23 and medium 38′ are located in an area 56 of the engine compartment 58 to conduct the hotter temperatures of the gases contained in downstream end 26′ of intake passageway 22′ away from medium 38′ during periods of engine shutdown such that temperature 60 of medium 38′ is lower than temperature 62 of the gases within passageway 22′ to thereby improve the efficiency of hydrocarbon adsorption. FIG. 9 shows embodiment 38-3′ wherein finned heat sink projections 64 extend from bottom wall 31 and/or side walls 42 to transfer heat away from sheet 54 and toward lower temperature 64 in area 56. It is understood that the use of finned heat sink projections 64 for improving the efficiency of cooling is equally applicable to all configurations of trap portions 23, 23′, 23″ and embodiments 38-1, 38-2 and 38-3, respectively.

What has been disclosed is an improved hydrocarbon trap system for collecting hydrocarbon emissions from an engine intake system during periods of engine shutdown, wherein the trap is formed as a low region within the intake air passageway itself, rather than as a separate pit adjacent to and communicating with the intake air passageway but separated therefrom by an imperforate wall, as in the prior art. While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A hydrocarbon vapor trap system for an internal combustion engine having a main air intake passageway, comprising:
a) a first portion in continuous series with said main air intake passageway and positioned vertically lower than adjacent portions of said main air intake passageway; and
b) a vapor adsorbent medium disposed in said first portion for adsorbing hydrocarbon vapors migrating outward from said engine through said passageway when said engine is shut down; and
a spoiler attached to an upper part of said first portion within said passageway for directing said migrating hydrocarbon vapors downwards toward said adsorbent medium.

2. A system in accordance with claim 1 wherein said first portion includes the lowest point in said main air intake passageway.

3. A system in accordance with claim 1 wherein said medium includes carbon.

4. A system in accordance with claim 3 wherein said carbon is activated carbon.

5. A system in accordance with claim 3 wherein said carbon is in a divided form selected from the group consisting of granulated and pelletized.

6. A system in accordance with claim 3 wherein said carbon is formed as a rigid structure.

7. A system in accordance with claim 3 wherein said carbon is formed as a sheet.

8. (canceled)

9. A system in accordance with claim 1 wherein said first portion is disposed in an engine compartment whereby heat is transferred away from said first portion during engine shut-down.

10. A system in accordance with Clam 9 wherein gases within said first portion are at a temperature and said medium is at a lower temperature than said temperature of said gases.

11. A system in accordance with claim 9 wherein said first portion of said main air intake passageway includes sidewalls and a bottom wall and at least one of said walls and said bottom wall includes at least one finned heat sink projection for transferring heat way from said first portion.

12. An internal combustion engine having a main engine air intake passageway disposed in an engine compartment comprising a hydrocarbon vapor trap system disposed in said passageway, said system including
a first portion of said main engine air intake passageway positioned vertically lower than adjacent portions of said passageway, and
a vapor adsorbent medium disposed in said first portion for adsorbing hydrocarbon vapors migrating outward from said engine through said passageway when said engine is shut down; and
a spoiler attached to an upper part of said first portion within said passageway for directing said migrating hydrocarbon vapors downwards toward said adsorbent medium.

13. An engine in accordance with claim 12 wherein said first portion is disposed in said engine compartment whereby heat is transferred away from said first portion during engine shut-down.

14. (canceled)
